(19) United States
(12) Patent Application Publication
(10) Pub. No.: US 2016/0098072 A1
(43) Pub. Date: Apr. 7, 2016

(54) CONTROL SYSTEM CAPABLE OF CONTROLLING ACTIVATING/DEACTIVATING OF MULTIPLE MOTHERBOARDS VIA CLOUD

(71) Applicant: ZIPPY TECHNOLOGY CORP., New Taipei City (TW)

(72) Inventors: Tsun-Te SHIH, New Taipei City (TW); Yu-Yuan CHANG, New Taipei City (TW); Kuang-Lung SHIH, New Taipei City (TW)

(21) Appl. No.: 14/505,215

(22) Filed: Oct. 2, 2014

(51) Int. Cl. G06F 1/26; G06F 1/32

(52) U.S. Cl. CPC G06F 1/266; G06F 1/3296

(57) ABSTRACT

A control system capable of controlling activating/deactivating of multiple motherboards via cloud includes a plurality of motherboards, a plurality of power supplies respectively corresponding to the motherboards, a cloud monitoring platform, and a power on/off control module connected to the motherboards and signally electrically connected to the cloud monitoring platform. The cloud monitoring platform includes a graphic control interface, and allows to a user to log in for operations to generate a control signal. After receiving the control signal, the power on/off control module analyzes the control signal to determine to output a trigger signal to at least one of the motherboards. In response to the trigger signal received, the motherboard outputs a power on/off signal to the corresponding power supply connected to turn on or turn of that power supply.

### FIELD OF THE INVENTION

The present invention relates to a control system for a computer device, and particularly to a control system capable of controlling activating/deactivating of multiple motherboards via cloud.

### BACKGROUND OF THE INVENTION

With the progress of remote control technologies, computer systems with Wake-on-LAN (WoL) are now common. With WoL, a user is allowed to control a computer system that is in a sleep mode or powered off via a Local Area Network (LAN) or Ethernet to cause the computer system to change from a sleep mode or a power-off state to a power-on state. To practice the WoL function, the computer system at least needs a motherboard that supports WoL and a network card that supports WoL. Further, the motherboard needs to be connected to the network card by a dedicated cable, in a way that the network card is allowed to draw a small amount of current from a power supply of the computer system when the computer system is powered off to monitor network frames. When the computer system is powered off, the network card continuously monitors whether the connected LAN or Ethernet has a magic packet, and captures the magic packet when the magic packet is identified. The network card further analyzes the magic packet, and prompts the computer system to output a power on/off signal to the power supply via the dedicated cable to power on the computer system.

Known from the above description, in the current implementation of the computer system, the network card captures the magic packet in the LAN or Ethernet. Therefore, when the computer system is installed with multiple motherboards, each of the motherboards is correspondingly installed with the network card that requires the WoL function, and each network card requires an independent dedicated cable. As such, the overall wiring may become extremely complex, leading to complications in activation/deactivation controls as well. Further, in the current WoL technology, instead of being able to control the activating/deactivating of the computer system at all times by connecting to a control end (the computer host) via the Internet, a user is only able to perform control operations from one control end.

### SUMMARY OF THE INVENTION

The primary object of the present invention is to solve issues of a conventional Wake-on-LAN (WoL) architecture for an architecture having multiple motherboards.

To achieve the above object, a control system capable of controlling activating/deactivating of multiple motherboards via cloud is provided by the present invention. The control system includes a plurality of motherboards, a plurality of power supplies, a cloud monitoring platform, and a power on/off control module. Each of the motherboards includes a device identity, and is controlled by a trigger signal to generate a power on/off signal. The power supplies are electrically connected to the motherboards, respectively, and are powered on or powered off when triggered by the respective power on/off signals outputted from the respective electrically connected motherboards. The cloud monitoring platform allows a user to log in for operations, is recorded with the device identities, and includes a graphic control interface. The graphic control interface includes a control selection field, which allows the user to individually select the motherboards such that the control signal includes the device identity of at least one motherboard selected by the user. The power on/off control module includes a signal receiving unit and an on/off control unit. The signal receiving unit is electrically connected to the cloud monitoring platform, and receives the control signal. The on/off control unit is connected to the signal receiving unit, and receives the control signal. The on-off control unit further analyzes the at least device identity included in the control signal, and outputs the trigger signal to at least one corresponding motherboard to cause the at least one motherboard receiving the trigger signal to output the power on/off signal to power on or power off the power supply.

In one embodiment, the cloud monitoring platform is established in a network host, and allows a user to log in via the Internet. The network host includes a transmission line, which is connected to the signal receiving unit to transmit signals.

In one embodiment, the power supplies output respective power operating signals to the respective motherboards connected. The power on/off control module receives the power operating signals from the respective motherboards and sends the power operating signals to be recorded at the cloud monitoring platform to the network host via the transmission line, so as to allow the user to learn operation statuses of the respective power supplies according to the respective power operating signals.

In one embodiment, the graphic control interface includes an operation status field that is displayed to indicate the operation statuses of the respective power supplies according to the respective power operating signals.

In one embodiment, the operation status field indicates the operation statuses of the respective power supplies by at least two different graphics.

In one embodiment, the user may utilize an Internet browser or a mobile application to log into the cloud monitoring platform via the Internet.

In one embodiment, the power on/off control module includes a network connecting unit, which is connected to the signal receiving unit to be further connected to the Internet. The cloud monitoring platform is disposed at a user end device. When the user operates the user end device to log into the cloud monitoring platform, the user end device is allowed to signally electrically connect to the power on/off control module via the Internet.

In one embodiment, the power supplies output respective power operating signals to the respective motherboards connected. The power on/off control module receives the power operating signals from the respective motherboards, and sends the power operating signals to the user end device established with the cloud monitoring platform by the network connecting unit via the Internet.

In one embodiment, the user end device may be one from a group consisting of a smart phone, a tablet computer and a laptop computer.

In one embodiment, the cloud monitoring platform may be established at the user end device by the mobile application.

In one embodiment, the power on/off control module is an independent circuit module from the motherboards.

In one embodiment, the power on/off control module includes a plurality of communication loops connected between the motherboards and the on/off control unit, respectively.

In one embodiment, each of the communication loops is provided with a control switch, which is controlled by the on/off control unit to output the trigger signal when turned on.

With the structure set forth above, the present invention has following features compared to a conventional solution.

1. In the present invention, the power on/off control module is connected to all of the motherboards, such that the motherboards need not be individually provided with additional WoL network cards and dedicated cables, thereby reducing production costs.

2. The present invention allows the user to log into the cloud monitoring platform via the Internet or using the user end device of the user to individually control the power supplies of the motherboards, thereby solving the issue of being able to perform control operations at only one control end as in the prior art.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of units according to an embodiment of the present invention;

FIG. 2 is a schematic diagram of units according to another embodiment of the present invention;

FIG. 3 is a partial schematic diagram according to another embodiment of the present invention;

FIG. 4A is a first schematic diagram of a graphic control interface according to an embodiment of the present invention; and

FIG. 4B is a second schematic diagram of a graphic control interface according to an embodiment of the present invention.

### DETAILED DESCRIPTION OF THE PREFERRED EMBODIMENTS

Details and technical contents of the present invention are given below with reference to the accompanying drawings.

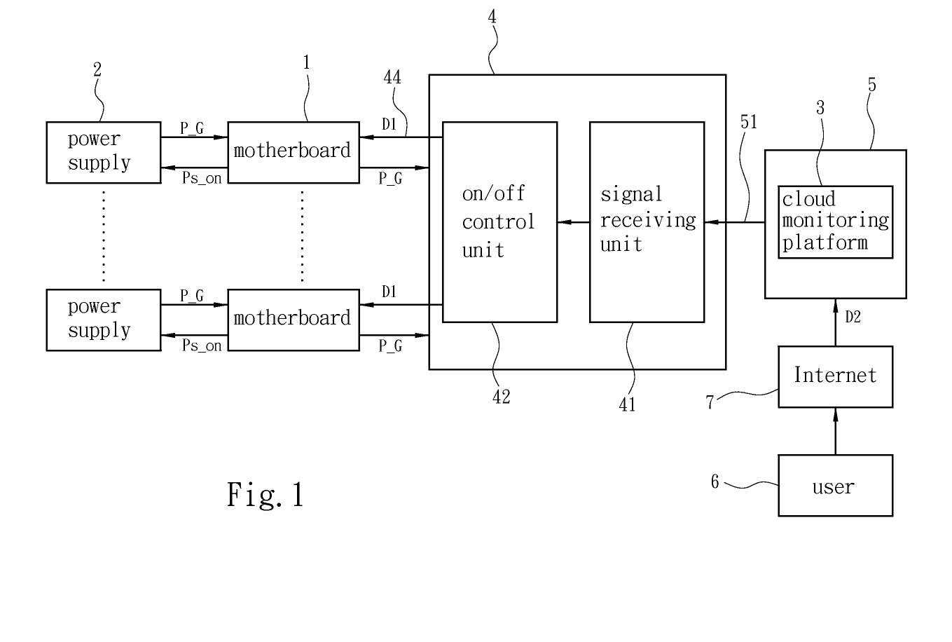

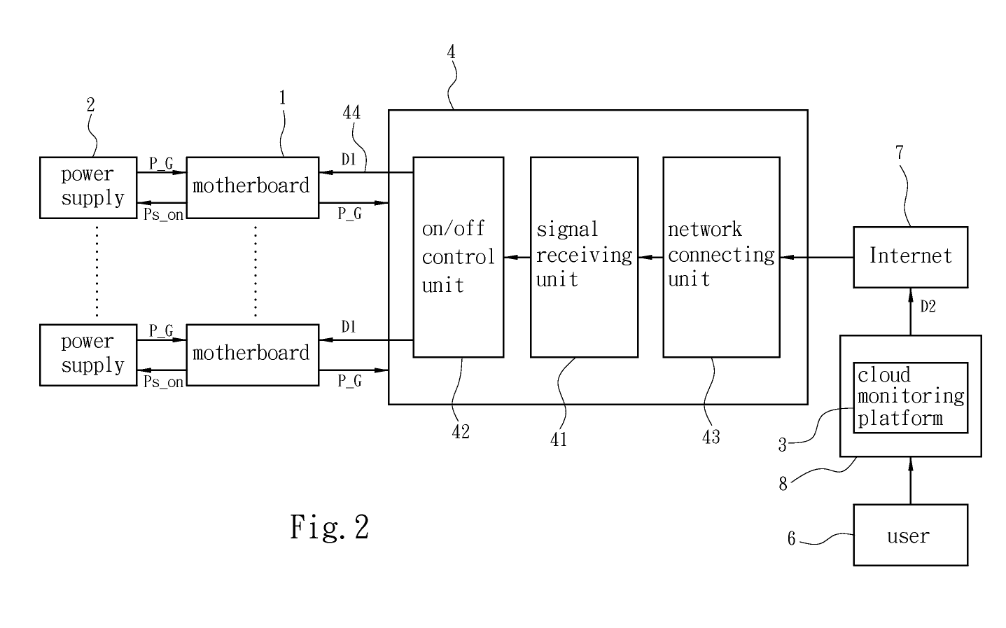

Referring to FIG. 1 and FIG. 2, a control system capable of controlling activating/deactivating of multiple motherboards via cloud of the present invention includes a plurality of motherboards 1, a plurality of power supplies 2, a cloud monitoring platform 3, and a power on/off control module 4. In one embodiment, each of the motherboards 1 has a unique device identity, and is controlled by a trigger signal D1 to generate a power on/off signal Ps₁₃on. The power supplies 2 are electrically connected to the motherboards 1, respectively, and are triggered by the respective power on/off signal Ps_on outputted by the respective motherboards 1 electrically connected to be powered on or powered off. In the embodiment, the cloud monitoring platform 3 may be established at a network host 5 by utilizing a logic program language. The network host 5 includes a transmission line 51 electrically connected to the power on/off control module 4, and allows a user 6 log into and connected to the cloud monitoring platform 3 via an Internet 7. After logging into and connecting to the cloud monitoring platform 3, the user 6 is able to perform appropriate operations to generate a control signal D2. The control signal D2 includes at least one device identity. Further, the user 6 may also log into the cloud monitoring platform 3 through an Internet server or a mobile application via the Internet 7.

The power on/off control module 4 is electrically connected to the motherboards 1, and logs into the cloud monitoring platform 5 via the transmission line 51 and the network host 5. More specifically, the power on/off control module 4 includes a signal receiving unit 41 and an on/off control unit 42. The signal receiving unit 41 is signally electrically connected to the cloud monitoring platform 3 via the transmission line 51 and the network host 5, and receives the control signal D2. The on/off control unit 42 is connected to the signal receiving unit 41, and receives the control unit D2. In one embodiment, by loading a logic program language, the on/off control unit 42 may be provided with an appropriate logic capability for analyzing digital information. In an implementation process of the present invention, the on/off control unit 42 analyzes at least one device identity included the control signal S2, and outputs the trigger signal D1 to the corresponding motherboard 1 according to the device identity. Thus, the motherboard 1 that receives the trigger signal D1 outputs the power on/off signal Ps_on to the corresponding power supply 2 connected to turn on or turn off the power supply 2.

A practical example is given below to better illustrate the implementation of the control system according to an embodiment of the present invention. To implement the control system of the present invention, the motherboards 1 are set with respective device identities, which are different from one another. In the embodiment, it is assumed that the device identity of one of the motherboards 1 is MB1, and the device identity of another of the motherboards 1 is MB2. Further, the device identities may be organized by a binary digital coding method. The two device identities of the two motherboards 1 are respectively recorded in the cloud monitoring platform 3 and the power on/off control module 4, such that the cloud monitoring platform 3 allows the user 6 to select the two motherboards 1 for further controls. The power on/off control module 3 is signally electrically connected to the network host 5 via the transmission line 51. The user 6 may later log into the cloud monitoring platform 3 for operations via the Internet 7 and the network host 5, and determine whether to activate one of the motherboards 1. When the user 6 determines to activate one of the motherboards 1, the user 6 may perform operations through the device identity displayed by the cloud monitoring platform 3. After the user 6 selects one of the motherboards 1 to be operated, the cloud monitoring platform 3 writes the device identity of the corresponding motherboard 1 into the control signal D2. In other words, the control signal D2 includes the information of “MB1”. Further, the cloud monitoring platform 3 outputs the control signal D2 to the power on/off control module 4 via the transmission line 51. Upon receiving the control signal D2 via the transmission line 51, the signal receiving unit 41 of the power on/off control module 4 immediately analyzes the information included in the control signal D2 by a logic program language, obtains the device identity in the code “MB1” carried in the control signal D2, searches for the motherboard 1 corresponding the device identity, and outputs the trigger signal D1 to the corresponding motherboard 1 of the two motherboards 1. After receiving the trigger signal D1, the motherboard 1 correspondingly generates and outputs the power on/off signal Ps_on to the power supply 2 connected to the motherboard 1. The power supply 2 immediately becomes turned on or turned off in response to the power on/off signal Ps_on received. More specifically, to deactivate the motherboard 1 connected to the power supply 2 when the power supply 2 is turned on, the user 6 may log into the cloud monitoring platform 3 for corresponding operations. Upon receiving the control signal D2, the power on/off control module 4 outputs the trigger signal D1 to the motherboard 1. After analyzing the trigger signal D1, the motherboard 1 outputs the power on/off signal Ps_on indicative of powering off to the power supply 2 to turn off the power supply. Further, the power on/off signal Ps_on may cause to the power supply 2 to be turned on or turned off by utilizing different potentials. For example, the power on/off signal Ps_on for controlling the power supply 2 to be turned on may be a low potential, whereas the power on/off signal Ps_on for controlling the power supply 2 to be turned off may be a high potential. Further, in the present invention, when the power supplies 2 are triggered by the power on/off signal Ps_on to become turned on from turned off, apart from providing power to the respective motherboards 1 connected, the power supplies 2 further generate a power operating system P_G at the same time. When any of the motherboard 1 receives the power operating signal P_G, the motherboard 1 determines that power required for operations is obtained and becomes turned on. Further, in the present invention, the power on/off control module 4 may receive the power operating signals P_G from the respective motherboards 1, and send the power operating signals P_G to the network host 5 to via the transmission line 51 to record the power operating signals P_G on the cloud monitoring platform 3. Thus, the user 6 may learn the operation statuses of the respective power supplies 2 according to the respective power operating signals P_G.

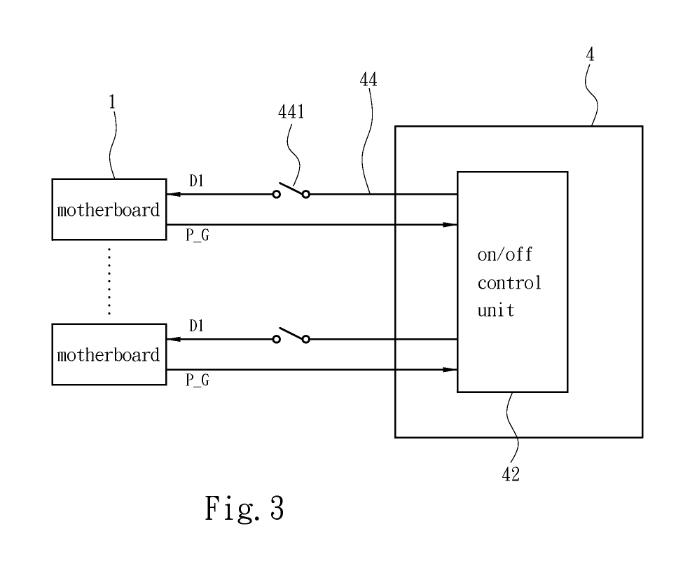

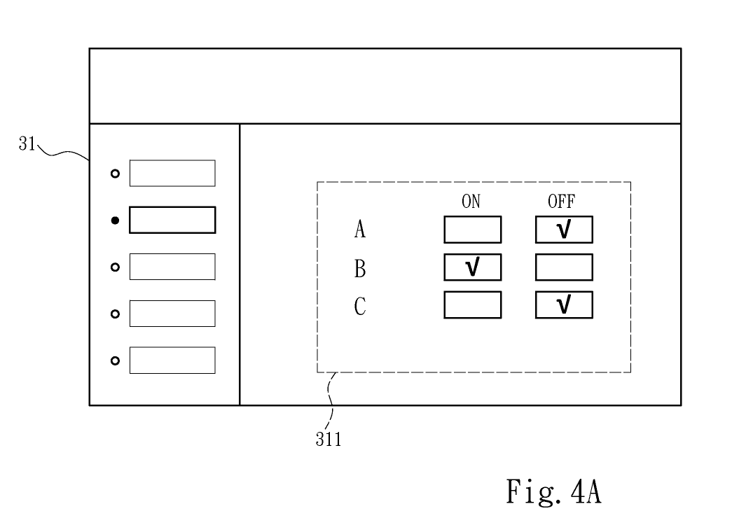

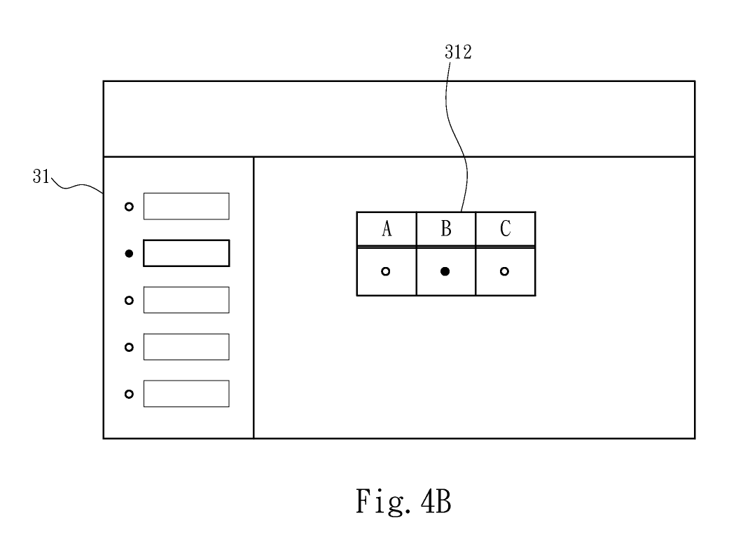

Referring to FIG. 3 to FIG. 4B, in addition to the foregoing embodiment, in the present invention, the power on/off control module 4 further includes a network connecting unit 43, which is connected to the signal receiving unit 41 and may be connected to the Internet 7. In the embodiment, the cloud monitoring platform 3 may be established at a user end device 8 by the mobile application. For example, the user end device 8 is one from a group consisting of a smart phone, a tablet computer and a laptop computer. Further, in the implementation process of the embodiment, the user 6 may log into the cloud monitoring platform 3 by utilizing the user end device 8 to signally electrically connect the power on/off control module 4 via the Internet. When the user 6 operates the cloud monitoring platform 3 and determines to control the activating or deactivating of one of the motherboards 1 connected to the power on/off control module 4, the control signal D2 generated by the cloud monitoring platform 3 may be transmitted to the signal receiving unit 41 via the Internet 7 and the network connecting unit 43. After analyzing the control signal D2, the power on/off control module 4 outputs the trigger signal D1 to one of the controlled motherboard 1 to control the corresponding power supply 2 to be turned on or turned off. Further, in the embodiment, the power supplies 2 similarly respectively output the power operating signals P_G when the power supplies 2 are turned on, and also provide the respective power operating signals P_G to the power on/off control module 4. The power on/off control module 4 may transmit the power operating signals P_G to the user end device 8 established with the cloud monitoring platform 3 via the network connecting unit 43.

Again referring to FIG. 3, in one embodiment of the present invention, the power on/off control module 4 is a circuit module independent from the motherboards 1. More specifically, the power on/off control module 4 includes a plurality of communication loops 44 respectively connected between the motherboards 1 and the on/off control unit 42, so as to allow the on/off control unit 42 to exchange signal electrical data between the communication loops 44 and the respective motherboards 1. Further, each of the communication loops 44 is provided with a control switch 441 controlled by the on/off control unit 42. The control switch 441 has two operation statuses—on and off. When the control switch 441 is turned on, the control switch 441 outputs the trigger signal D1 to the corresponding motherboard 1.

Referring to FIG. 4A, it is known from the above description that, the cloud monitoring platform 3 of the present invention allows the user 6 to log into the cloud monitoring platform 3 via the Internet 7 to perform appropriate control operations. In one embodiment of the present invention, the cloud monitoring platform 3 further includes a graphic control interface 31. The graphics interface 31 may be in a HyperText Markup Language (HTML) loaded on the cloud monitoring platform 3. The graphic control interface 31 includes a control selection field 311. The control selection field 311 allows the user 6 to select one of the motherboards 1, such that the control signal D2 includes the device identity of the motherboard 1 selected by the user 6. Further, the control selection field 311 may include a plurality of selection boxes for the user 6 to select from. To better illustrate the embodiment, in FIG. 4A and FIG. 4B, the power supplies 2 are respectively denoted as A, B and C, for example. Referring to FIG. 4B, in one embodiment of the present invention, the graphic control interface 31 further includes an operation status field 312. The operation status 312 is displayed according to the power operating signals P_G to indicate the operation statuses of the respective power supplies 2. More specifically, the operation status field 312 may indicate the operation status of each of the power supplies 2 by at least two different graphics. For example, in the operation status field 312, a solid circle indicates that the corresponding power supply 2 is turned on, and a hollow circle indicates that the corresponding power supply is turned off. Further, when the cloud monitoring platform 3 obtains the power operating signal P_G of the corresponding power supply 2 via the Internet 7, it means that the corresponding power supply 2 is turned on. More specifically, in the present invention, only the power supplies 2 that are turned on output the respective power operating signals P_G to the respective motherboards 1, whereas the power supplies 2 that are turned off do not generate the power operating signals P_G at all. Thus, by merely determining whether the power operating signals P_G of the respective power supplies 2 recorded on the cloud monitoring platform 3 are received, the cloud monitoring platform 3 may learn the operation statuses of the respective power supplies.

In conclusion, the control system capable of controlling activating/deactivating of multiple motherboards via cloud includes a plurality of motherboards, a plurality of power supplies respectively corresponding and connected to the motherboards, a cloud monitoring platform, and a power on/off control module connected to the motherboards and signally electrically connected to the cloud monitoring platform. The cloud monitoring platform includes a graphic control interface, and allows a user to log in for operations to generate a control signal. After receiving the control signal, the power on/off control module analyzes the control signal to determine to output a trigger signal to at least one of the motherboards. As such, in response to the trigger signal received, the corresponding motherboard outputs a power on/off signal to the power supply connected to turn on or turn of the power supply, thereby simplifying complicated conventional wiring and providing a cloud control function.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A control system capable of controlling activating/deactivating of multiple motherboards via cloud, comprising:
a plurality of motherboards, having respective device identities, controlled by a trigger signal to generate respective power on/off signals;
a plurality of power supplies, respectively electrically connected to the motherboards, triggered by the respective power on/off signals outputted from the respective motherboards connected to be turned on or turned off;
a cloud monitoring platform, configured to allow a user to log in for operations and recorded with the device identities, comprising:
a graphic control interface, comprising a control selection field that allows the user to select at least one of the motherboards such that a control signal comprises the device identity of the at least one motherboard selected by the user; and
a power on/off control module, comprising:
a signal receiving unit, signally electrically connected to the cloud monitoring platform, configured to receive the control signal, and
an on/off control unit, connected to the signal receiving unit, configured to receive the control signal, to analyze at least one device identity included in the control signal, and to output the trigger signal to the at least one motherboard corresponding to the device identity, such that the at least one motherboard that receives the trigger signal outputs the power on/off signal to turn on or turn off the corresponding power supply.

2. The control system capable of controlling activating/deactivating of multiple motherboards via cloud of claim 1, wherein the cloud monitoring platform is established in a network host and allows the user to be logged in via an Internet, the network host comprising a transmission line connected to the signal receiving unit to transmit signals.

3. The control system capable of controlling activating/deactivating of multiple motherboards via cloud of claim 2, wherein the power supplies output respective power operating signals to the respective motherboards connected; the power on/off control module receive the power operating signals from the respective motherboards, and sends the power operating signals to the network host via the transmission line to record the power operating signals at the cloud monitoring platform to allow the user to learn operation statuses of the respective power supplies according to the respective power operating signals.

4. The control system capable of controlling activating/deactivating of multiple motherboards via cloud of claim 3, wherein the graphic control interface comprises an operation status field that is displayed according to the power operation signals to indicate the operation statuses of the respective power supplies.

5. The control system capable of controlling activating/deactivating of multiple motherboards via cloud of claim 4, wherein the operation status field indicates the operation statuses of the respective power supplies by at least two different graphics.

6. The control system capable of controlling activating/deactivating of multiple motherboards via cloud of claim 2, wherein the user utilizes an Internet server, a mobile application or a mail server to log into the cloud monitoring platform via the Internet.

7. The control system capable of controlling activating/deactivating of multiple motherboards via cloud of claim 1, wherein the power on/off control module comprises a network connecting unit connected to the signal receiving unit to be further connected to an Internet; the cloud monitoring platform is disposed at a user end device; when the user operates the user end device to log into the cloud monitoring platform, the user end device is able to signally electrically connect to the power on/off control module via the Internet.

8. The control system capable of controlling activating/deactivating of multiple motherboards via cloud of claim 7, wherein the power supplies output power operating signals to the motherboards connected when powered on, and power on/off control module receives the power operating signals from the respective motherboards and sends the power operating signals to the user end device established with the cloud monitoring platform.

9. The control system capable of controlling activating/deactivating of multiple motherboards via cloud of claim 7, wherein the graphic control interface comprises an operation status field that is displayed according to the power operation signals to indicate the operation statuses of the respective power supplies.

10. The control system capable of controlling activating/deactivating of multiple motherboards via cloud of claim 9, wherein the operation status field indicates the operation statuses of the respective power supplies by at least two different graphics.

11. The control system capable of controlling activating/deactivating of multiple motherboards via cloud of claim 7, wherein the user end device is one from a group consisting of a smart phone, a tablet computer and a laptop computer.

12. The control system capable of controlling activating/deactivating of multiple motherboards via cloud of claim 11, wherein the cloud monitoring platform is established by a mobile application at the user end device.

13. The control system capable of controlling activating/deactivating of multiple motherboards via cloud of claim 1, wherein the power on/off control module is a circuit module independent from the motherboards.

14. The control system capable of controlling activating/deactivating of multiple motherboards via cloud of claim 13, wherein the power on/off control module comprises a plurality of communication loops connected between the motherboards and the on/off control unit, respectively.

15. The control system capable of controlling activating/deactivating of multiple motherboards via cloud of claim 14, wherein each of the communication loops is provided with a control switch, which is controlled by the on/off control unit to output the trigger signal when turned on.
